(19) United States
(12) Patent Application Publication
(10) Pub. No.: US 2020/0136406 A1
(43) Pub. Date: Apr. 30, 2020

(54) VEHICLE

(71) Applicant: Toyota Jidosha Kabushiki Kaisha, Toyota-shi (JP)

(72) Inventors: Takeaki SUZUKI, Toyota-shi (JP); Yuya Ando, Toyota-shi (JP); Shinsuke Iwasaki, Toyota-shi (JP); Miki Sugita, Toyota-shi (JP)

(73) Assignee: Toyota Jidosha Kabushiki Kaisha, Toyota-shi (JP)

(21) Appl. No.: 16/659,643

(22) Filed: Oct. 22, 2019

(30) Foreign Application Priority Data
Oct. 29, 2018 (JP) 2018-202517

(51) Int. Cl. H02J 7/00; H02P 11/04; B60L 50/52

(52) U.S. Cl. CPC H02J 7/0032; B60L 50/52; H02P 11/04

(57) ABSTRACT

A vehicle comprises a first power storage device; a second power storage device configured to have a lower rated voltage than a rated voltage of the first power storage device; a DC-DC converter configured to step down a voltage of electric power of a high voltage-side power line which the first power storage device is connected with and to supply the electric power of the stepped-down voltage to a low voltage-side power line which the second power storage device is connected with; a first auxiliary machine connected with the low voltage-side power line and configured such as to be required to operate in a system off-state; a second auxiliary machine connected with the low voltage-side power line and configured such as not to be required to operate in the system off-state; and a switch configured to disconnect the second auxiliary machine from the low voltage-side power line.

### CROSS-REFERENCE TO RELATED APPLICATIONS

The present disclosure claims priority to Japanese Patent Application No. 2018-202517 filed Oct. 29, 2018, which is incorporated herein by reference in its entirety including specification, drawings and claims.

### TECHNICAL FIELD

The present disclosure relates to a vehicle.

### BACKGROUND

A proposed configuration of a vehicle includes a main power storage device, an auxiliary machinery battery, a DC-DC converter configured to step down the voltage of electric power of a high voltage-side power line which the main power storage device is connected with and to supply the electric power of the stepped-down voltage to a low voltage-side power line which the auxiliary machinery battery is connected with, and auxiliary machinery connected with the low voltage-side power line (as described in, for example, JP 2014-143868A). When a parking time of this vehicle reaches or exceeds a predetermined time period, the vehicle of this configuration drives the DC-DC converter to supply the electric power of the main power storage device to the auxiliary machinery battery and thereby charge the auxiliary machinery battery with the supplied electric power.

### SUMMARY

In the vehicle of the above configuration, not only the auxiliary machinery battery but the auxiliary machinery is connected with the low voltage-side power line. Accordingly, dark current is supplied to the auxiliary machinery in a system off-state. This reduces the state of charge or the voltage of the auxiliary machinery battery. This configuration causes dark current to be supplied to the entire auxiliary machinery, although the auxiliary machinery includes some auxiliary machines that are not required to operate in the system off-state. This causes an excessive reduction of the state of charge or the voltage of the auxiliary machinery battery.

A main object of a vehicle of the present disclosure is to restrict an amount of reduction in state of charge or in voltage of an auxiliary machinery battery.

In order to achieve the main object described above, the present disclosure is implemented by aspects of a vehicle described above.

According to one aspect of the present disclosure, there is provided a vehicle including a first power storage device, a second power storage device configured to have a lower rated voltage than a rated voltage of the first power storage device, a DC-DC converter configured to step down a voltage of electric power of a high voltage-side power line which the first power storage device is connected with and to supply the electric power of the stepped-down voltage to a low voltage-side power line which the second power storage device is connected with, a first auxiliary machine connected with the low voltage-side power line and configured such as to be required to operate in a system off-state, a second auxiliary machine connected with the low voltage-side power line and configured such as not to be required to operate in the system off-state and a switch configured to disconnect the second auxiliary machine from the low voltage-side power line.

The vehicle according to this aspect of the present disclosure comprises the first power storage device; the second power storage device configured to have the lower rated voltage than the rated voltage of the first power storage device; the DC-DC converter configured to step down the voltage of the electric power of the high voltage-side power line which the first power storage device is connected with and to supply the electric power of the stepped-down voltage to the low voltage-side power line which the second power storage device is connected with; the first auxiliary machine connected with the low voltage-side power line and configured such as to be required to operate in the system off-state; the second auxiliary machine connected with the low voltage-side power line and configured such as not to be required to operate in the system off-state; and the switch configured to disconnect the second auxiliary machine from the low voltage-side power line. This configuration disconnects the second auxiliary machine from the low voltage-side power line by means of the switch in the system off-state. As a result, this prevents dark current from being supplied to the second auxiliary machine and restricts an amount of reduction in the state of charge or in the voltage of the second power storage device.

The “first auxiliary machine” herein denotes an auxiliary machine that is required to operate in the system off-state and includes, for example, an auxiliary machine involved in vehicle theft prevention or security (for example, a horn and an emergency flasher). The second auxiliary machine herein denotes an auxiliary machine that is not required to operate in the system off-state and is an auxiliary machine that is not included in the first auxiliary machine (for example, a vehicle audio system and powered window).

### BRIEF DESCRIPTION OF DRAWINGS

FIG. 1 is a configuration diagram illustrating the schematic configuration of an electric vehicle according to a first embodiment of the present disclosure;

FIG. 2 is a flowchart showing one example of a system off-state processing routine performed by the electronic control unit;

FIG. 3 is a diagram illustrating one example of the state when the electric vehicle is left in the system off-state;

FIG. 4 is a diagram illustrating the schematic configuration of an electric vehicle according to a second embodiment;

FIG. 5 is a flowchart showing one example of a system off-state processing routine according to the second embodiment; and

FIG. 6 is a diagram illustrating one example of the state when the electric vehicle is left in the system off-state according to the second embodiment.

### DESCRIPTION OF EMBODIMENTS

The following describes some aspects of the present disclosure with reference to an embodiment.

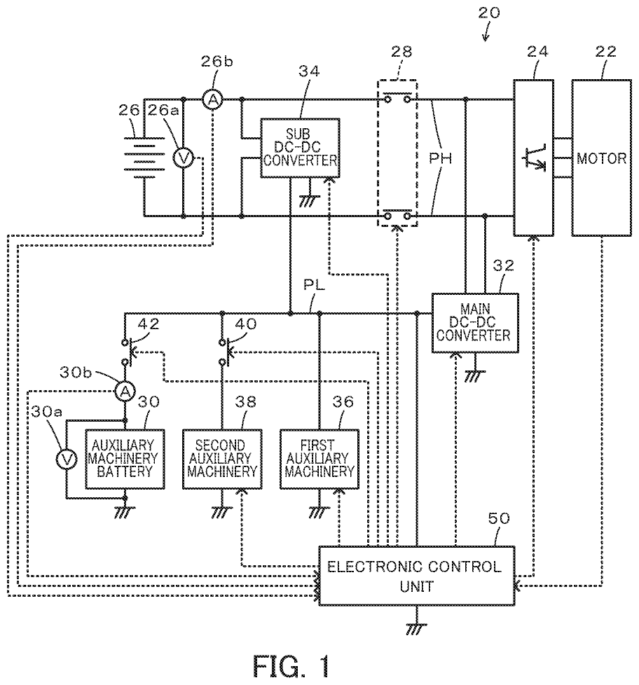

FIG. 1 is a configuration diagram illustrating the schematic configuration of an electric vehicle 20 according to a first embodiment of the present disclosure. As illustrated, the electric vehicle 20 of the first embodiment includes a motor 22, an inverter 24, a main battery 26 serving as a first power storage device, a system main relay 28, an auxiliary machinery battery 30 serving as a second power storage device, a main DC-DC converter 32, a sub DC-DC converter 34, first auxiliary machinery 36, second auxiliary machinery 38, switches 40 and 42, and an electronic control unit 50.

The motor 22 is configured as, for example, a synchronous generator motor and serves to output power for driving. The inverter 24 is used to drive the motor 22. The main battery 26 is configured as, for example, a lithium ion rechargeable battery or a nickel metal hydride battery having a rated voltage of about several hundred V and is connected with the inverter 24 via high voltage-side power lines PH. The system main relay 28 is provided on the high voltage-side power lines PH and serves to connect and disconnect the inverter 24-side with and from the main battery 26-side.

The auxiliary machinery battery 30 is configured as, for example, a lead acid battery having a rated voltage of 12 V. The main DC-DC converter 32 is configured as, for example, a converter having a rated current of about several ten A and is connected with the inverter 24-side of the system main relay 28 in the high voltage-side power lines PH and with a low voltage-side power line PL. This main DC-DC converter 32 serves to step down the voltage of the electric power of the high voltage-side power lines PH and to supply the electric power of the stepped-down voltage to the low voltage-side power line PL.

The sub DC-DC converter 34 is configured as, for example, a converter having a rated current of about several ten mA (for supply of dark current) and is connected with the main battery 26-side of the system main relay 28 in the high voltage-side power lines PH and with the low voltage-side power line PL. This sub DC-DC converter 34 serves to step down the voltage of the electric power of the high voltage-side power lines PH and to supply the electric power of the stepped-down voltage to the low voltage-side power line PL.

The first auxiliary machinery 36 denotes auxiliary machines that are required to operate in a system off-state and includes, for example, auxiliary machines involved in vehicle theft prevention and security (for example, a horn and an emergency flasher). The second auxiliary machinery 38 denotes auxiliary machines that are not required to operate in the system off-state and is auxiliary machines that are not included in the first auxiliary machinery 36 (for example, a vehicle audio system and powered windows).

The switch 40 is configured as a normally closed switch and has one side connected with the low voltage-side power line PL and the other side connected with the second auxiliary machinery 38. The switch 42 is configured as a normally closed switch and has one side connected with the low voltage-side power line PL and the other side connected with the auxiliary machinery battery 30.

The electronic control unit 50 is configured as a CPU-based microprocessor and includes a ROM configured to store processing programs, a RAM configured to temporarily store data and input/output ports, in addition to the CPU, although not being illustrated. Signals from various sensors are input into the electronic control unit 50 via the input port. The signals input into the electronic control unit 50 include, for example, a rotational position from a rotational position sensor (not shown) configured to detect a rotating position of a rotor of the motor 22 and phase currents from current sensors (not shown) configured to detect electric currents flowing through respective phases of the motor 22. The input signals also include a voltage Vmb of the main battery 26 from a voltage sensor 26a placed between terminals of the main battery 26, an electric current Imb of the main battery 26 from a current sensor 26bmounted to an output terminal of the main battery 26, a voltage Vab of the auxiliary machinery battery 30 from a voltage sensor 30a placed between terminals of the auxiliary machinery battery 30, and an electric current Iab of the auxiliary machinery battery 30 from a current sensor 30b mounted to an output terminal of the auxiliary machinery battery 30.

Various control signals are output from the electronic control unit 50 via the output port. The signals output from the electronic control unit 50 via the output port include, for example, control signals to the inverter 24, control signals to the system main relay 28, control signals to the main DC-DC converter 32, control signals to the sub DC-DC converter 34, control signals to the first auxiliary machinery 36 and control signals to the second auxiliary machinery 38.

The electronic control unit 50 calculates a state of charge SOCmb of the main battery 26, based on an integrated value of the electric current Imb of the main battery 26 input from the current sensor 26b. The electronic control unit 50 also calculates a state of charge SOCab of the auxiliary machinery battery 30, based on an integrated value of the electric current Iab of the auxiliary machinery battery 30 input from the current sensor 30b.

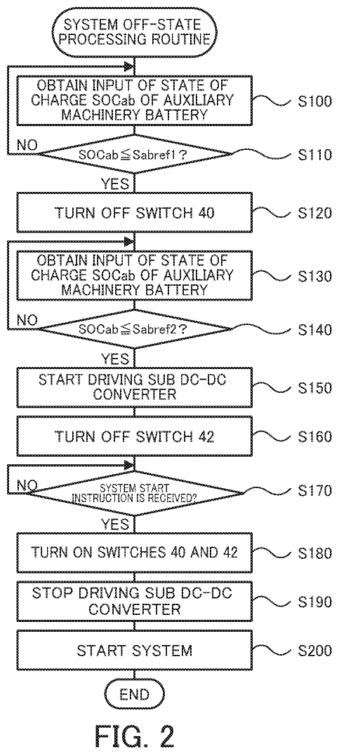

The following describes operations of the electric vehicle 20 of the first embodiment configured as described above or more specifically a series of operations with the electric vehicle 20 is left in the system off-state for a relatively long time period. FIG. 2 is a flowchart showing one example of a system off-state processing routine performed by the electronic control unit 50. This routine is triggered by a start of the system off-state.

When the system off-state processing routine of FIG. 2 is triggered, the electronic control unit 50 first obtains the input of the state of charge SOCab of the auxiliary machinery battery 30 from the current sensor 30b (step S100) and compares the input state of charge SOCab of the auxiliary machinery battery 30 with a reference value Sabref1 (step S110). The reference value Sabref1 used herein denotes a threshold value used to determine whether it is allowed to supply dark current from the auxiliary machinery battery 30 to the second auxiliary machinery 38 and is, for example, 38%, 40% or 42%. When the state of charge SOCab of the auxiliary machinery battery 30 is higher than the reference value Sabref1, the electronic control unit 50 returns the processing routine to step S100.

When the state of charge SOCab of the auxiliary machinery battery 30 is equal to or lower than the reference value Sabref1 at step S110, on the other hand, the electronic control unit 50 turns off the switch 40 (step S120). Turning off the switch 40 disconnects the second auxiliary machinery 38 from the low voltage-side power line PL and thereby prevents the dark current from being supplied from the auxiliary machinery battery 30 to the second auxiliary machinery 38. This accordingly limits an amount of discharge from the auxiliary machinery battery 30 and thereby restricts an amount of reduction in the state of charge SOCab of the auxiliary machinery battery 30. Even in this state, dark current is supplied from the auxiliary machinery battery 30 to the first auxiliary machinery 36.

The electronic control unit 50 subsequently obtains the input of the state of charge SOCab of the auxiliary machinery battery 30 from the current sensor 30b (step S130) and compares the input state of charge SOCab of the auxiliary machinery battery 30 with a reference value Sabref2 that is lower than the reference value Sabref1 (step S140). When the state of charge SOCab of the auxiliary machinery battery 30 is higher than the reference value Sabref2, the electronic control unit 50 returns the processing routine to step S130. The reference value Sabref2 used herein is determined as a value of the state of charge SOCab required for a next system start or a slightly higher value of the state of charge SOCab and is, for example, 28%, 30% or 32%.

When the state of charge SOCab of the auxiliary machinery battery 30 is equal to or lower than the reference value Sabref2 at step S140, on the other hand, the electronic control unit 50 starts driving the sub DC-DC converter 34 to step down the voltage of the electric power of the high voltage-side power lines PH (i.e., the electric power of the main battery 26) and supply the electric power of the stepped-down voltage to the low voltage-side power line PL (step S150) and subsequently turns off the switch 42 (step S160). Turning off the switch 42 disconnects the auxiliary machinery battery 30 from the low voltage-side power line PL. This restricts subsequent discharge from the auxiliary machinery battery 30 and thereby causes the state of charge SOCab required for a subsequent system start to be kept in the auxiliary machinery battery 30. Driving the sub DC-DC converter 34 enables the dark current to be supplied from the main battery 26 via the sub DC-DC converter 34 to the first auxiliary machinery 36 without turning on the system main relay 28, i.e., without connecting the inverter 24 with the main battery 26. Furthermore, turning off the switch 42 after the start of driving the sub DC-DC converter 34 prevents interruption of the supply of dark current to the first auxiliary machinery 36.

The electronic control unit 50 subsequently waits for receiving a system start instruction (step S170). The system start instruction is received when the user operates a start switch (not shown). When receiving the system start instruction, the electronic control unit 50 turns on the switches 40 and 42 to connect the second auxiliary machinery and the auxiliary machinery battery 30 with the low voltage-side power line PL (step S180), stops driving the sub DC-DC converter 34 (step S190), starts the system (step S200) and then terminates this processing routine. According to an exemplified procedure of starting the system, the electronic control unit 50 turns on the system main relay 28 to connect the main battery 26 with the inverter 24 (to make the motor 22 drivable).

The electronic control unit 50 is likely to receive the system start instruction before turning off the switch 42 (i.e., before performing the processing of step S160) in the course of this processing routine. In this state, the auxiliary machinery battery 30 is connected with the low voltage-side power line PL, so that the electronic control unit 50 turns on the switch 40 if the switch 40 is off, and then starts the system.

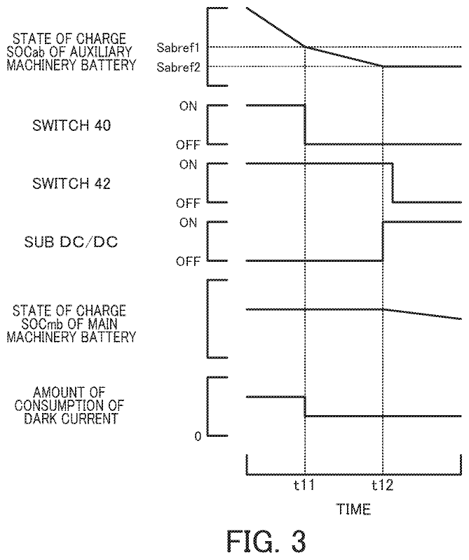

FIG. 3 is a diagram illustrating one example of the state when the electric vehicle 20 is left in the system off-state. As illustrated, in the system off-state, when the supply of dark current from the auxiliary machinery battery 30 to the first auxiliary machinery 36 and to the second auxiliary machinery 38 reduces the state of charge SOCab of the auxiliary machinery battery 30 to become equal to or lower than the reference value Sabref1 (at a time t11), the electric vehicle 20 turns off the switch 40 to disconnect the second auxiliary machinery 38 from the low voltage-side power line PL. This limits the amount of discharge from the auxiliary machinery battery 30 and thereby restricts the amount of reduction in the state of charge SOCab of the auxiliary machinery battery 30.

When subsequent supply of dark current from the auxiliary machinery battery 30 to the first auxiliary machinery 36 reduces the state of charge SOCab of the auxiliary machinery battery 30 to become equal to or lower than the reference value Sabref2 (at a time t12), the electric vehicle 20 starts driving the sub DC-DC converter 34 and subsequently turns off the switch 42. This enables the dark current to be supplied from the main battery 26 via the sub DC-DC converter 34 to the first auxiliary machinery 36, while preventing interruption of the supply of dark current to the first auxiliary machinery 36. This also restricts subsequent discharge from the auxiliary machinery battery 30 and causes the state of charge SOCab required for a subsequent system start to be kept in the auxiliary machinery battery 30.

As described above, the electric vehicle 20 of the first embodiment is provided with the switch 40 that is configured to disconnect the second auxiliary machinery 38 from the low voltage-side power line PL. In the system off-state, when the state of charge SOCab of the auxiliary machinery battery 30 becomes equal to or lower than the reference value Sabref1, the electric vehicle 20 turns off the switch 40 to disconnect the second auxiliary machinery 38 from the low voltage-side power line PL. This limits the amount of discharge from the auxiliary machinery battery 30 and thereby restricts the amount of reduction in the state of charge SOCab of the auxiliary machinery battery 30.

The electric vehicle 20 of the first embodiment is further provided with the switch 42 that is configured to disconnect the auxiliary machinery battery 30 from the low voltage-side power line PL. In the system off-state, when the state of charge SOCab of the auxiliary machinery battery 30 becomes equal to or lower than the reference value Sabref2 after turning-off of the switch 40, the electric vehicle 20 starts driving the sub DC-DC converter 34 and subsequently turns off the switch 42. This enables the dark current to be supplied from the main battery 26 via the sub DC-DC converter 34 to the first auxiliary machinery 36, while preventing interruption of the supply of dark current to the first auxiliary machinery 36.

This also restricts subsequent discharge from the auxiliary machinery battery 30 and causes the state of charge SOCab required for a subsequent system start to be kept in the auxiliary machinery battery 30.

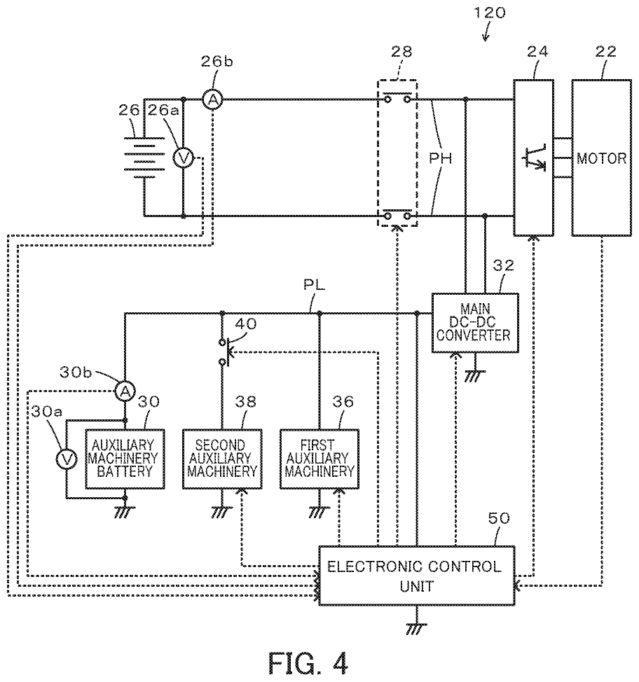

FIG. 4 is a diagram illustrating the schematic configuration of an electric vehicle 120 according to a second embodiment. The electric vehicle 120 of the second embodiment has a similar configuration to that of the electric vehicle 20 of the first embodiment shown in FIG. 1, except that the electric vehicle 120 is neither provided with the sub DC-DC converter 34 nor provided with the switch 42 and that the auxiliary machinery battery 30 is directly connected with the low voltage-side power line PL. Like hardware components in the electric vehicle 120 of the second embodiment to those in the electric vehicle 20 of the first embodiment are expressed by like reference signs, and their detailed description is omitted.

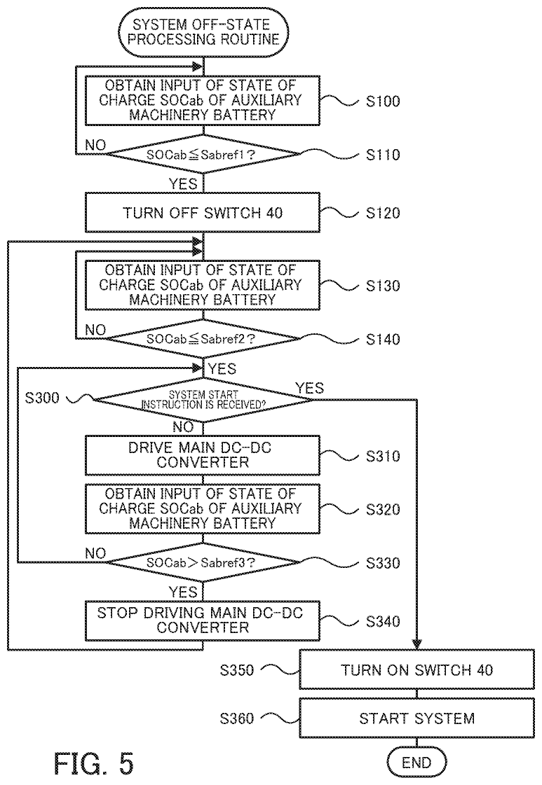

In the electric vehicle 120 of the second embodiment, the electronic control unit 50 performs a system off-state processing routine of FIG. 5, in place of the system off-state processing routine of FIG. 2. The system off-state processing routine of FIG. 5 is similar to the system off-state processing routine of FIG. 2, except that the processing of steps S150 to S200 is replaced by the processing of steps S300 to S360. Like processing steps are expressed by like step numbers, and their detailed description is omitted.

In the system off-state processing routine of FIG. 5, when the state of charge SOCab of the auxiliary machinery battery 30 is equal to or lower than the reference value Sabref2 at step S140, the electronic control unit 50 determines whether the system start instruction is received (step S300). When it is determined that no system start instruction is received, the electronic control unit 50 drives the main DC-DC converter 32 to step down the voltage of the electric power of the high voltage-side power lines PH (i.e., the electric power of the main battery 26) and supply the electric power of the stepped-down voltage to the low voltage-side power line PL (step S310). Driving the main DC-DC converter 32 enables dark current to be supplied from the main battery 26 via the main DC-DC converter 32 to the auxiliary machinery battery 30 and to the first auxiliary machinery 36. This restricts further discharge from the auxiliary machinery battery 30 and causes the state of charge SOCab required for a subsequent system start to be kept in the auxiliary machinery battery 30. The main DC-DC converter 32 has a higher rated current than that of the sub DC-DC converter 34 and accordingly has lower controllability with respect to small electric current. The auxiliary machinery battery 30, however, serves as a buffer and enables the dark current to be supplied to the first auxiliary machinery 36.

The electronic control unit 50 subsequently obtains the input of the state of charge SOCab of the auxiliary machinery battery 30 from the current sensor 30b (step S320) and compares the input state of charge SOCab of the auxiliary machinery battery 30 with a reference value Sabref3 that is lower than the reference value Sabref1 but is higher than the reference value Sabref2 (step S330). The reference value Sabref3 used herein denotes a threshold value used to determine whether the state of charge SOCab of the auxiliary machinery battery 30 has been recovered to some extent and is, for example, 34%, 35% or 36%. When the state of charge SOCab of the auxiliary machinery battery 30 is equal to or lower than the reference value Sabref3, the electronic control unit 50 returns the processing routine to step S300. When the state of charge SOCab of the auxiliary machinery battery 30 is higher than the reference value Sabref3, on the other hand, the electronic control unit 50 stops driving the main DC-DC converter 32 (step S340) and then returns the processing routine to step S130.

When it is determined at step S300 that the system start instruction is received, the electronic control unit 50 turns on the switch 40 (step S350), starts the system (step S360) and then terminates this processing routine.

The electronic control unit 50 is likely to receive the system start instruction during execution of the processing of steps S100 to S140 in the course of this processing routine. In this state, the electronic control unit 50 turns on the switch 40 if the switch 40 is off, and then starts the system.

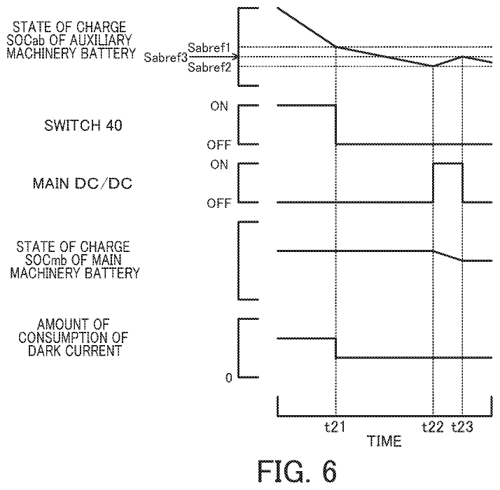

FIG. 6 is a diagram illustrating one example of the state when the electric vehicle 120 is left in the system off-state. As illustrated, in the system off-state, when the supply of dark current from the auxiliary machinery battery 30 to the first auxiliary machinery 36 and to the second auxiliary machinery 38 reduces the state of charge SOCab of the auxiliary machinery battery 30 to become equal to or lower than the reference value Sabref1 (at a time t21), the electric vehicle 120 turns off the switch 40 to disconnect the second auxiliary machinery 38 from the low voltage-side power line PL. This limits the amount of discharge from the auxiliary machinery battery 30 and thereby restricts the amount of reduction in the state of charge SOCab of the auxiliary machinery battery 30. When subsequent supply of dark current from the auxiliary machinery battery 30 to the first auxiliary machinery 36 reduces the state of charge SOCab of the auxiliary machinery battery 30 to become equal to or lower than the reference value Sabref2 (at a time t22), the electric vehicle 120 starts driving the main DC-DC converter 32. This enables electric current to be supplied from the main battery 26 via the main DC-DC converter 32 to the auxiliary machinery battery 30 and to the first auxiliary machinery 36. As a result, this restricts further discharge from the auxiliary machinery battery 30 and causes the state of charge SOCab required for a subsequent system start to be kept in the auxiliary machinery battery 30. When the auxiliary machinery battery 30 is charged to increase the state of charge SOCab of the auxiliary machinery battery 30 to be higher than the reference value Sabref3 (at a time t23), the electric vehicle 120 stops driving the main DC-DC converter 32.

As described above, like the electric vehicle 20 of the first embodiment, the electric vehicle 120 of the second embodiment is provided with the switch 40 that is configured to disconnect the second auxiliary machinery 38 from the low voltage-side power line PL. When the state of charge SOCab of the auxiliary machinery battery 30 becomes equal to or lower than the reference value Sabref1 in the system off-state, the electric vehicle 120 turns off the switch 40 to disconnect the second auxiliary machinery 38 from the low voltage-side power line PL. This limits the amount of discharge from the auxiliary machinery battery 30 and thereby restricts the amount of reduction in the state of charge SOCab of the auxiliary machinery battery 30.

Furthermore, in the system off-state, when the state of charge SOCab of the auxiliary machinery battery 30 becomes equal to or lower than the reference value Sabref2 after turning-off of the switch 40, the electric vehicle 120 of the second embodiment drives the main DC-DC converter 32. This enables electric current to be supplied from the main battery 26 via the main DC-DC converter 32 to the auxiliary machinery battery 30 and to the first auxiliary machinery 36. As a result, this restricts further discharge from the auxiliary machinery battery 30 and causes the state of charge SOCab required for a subsequent system start to be kept in the auxiliary machinery battery 30.

In the system off-state, when the state of charge SOCab of the auxiliary machinery battery 30 becomes equal to or lower than the reference value Sabref1, the electric vehicle 20 of the first embodiment or the electric vehicle 120 of the second embodiment turns off the switch 40 to disconnect the second auxiliary machinery 38 from the low voltage-side power line PL. In the system off-state, a modification may turn off the switch 40 to disconnect the second auxiliary machinery 38 from the low voltage-side power line PL irrespective of the state of charge SOCab of the auxiliary machinery battery 30, in response to the user's instruction to turn off the switch 40.

The electric vehicle 20 of the first embodiment or the electric vehicle 120 of the second embodiment compares the state of charge SOCab of the auxiliary machinery battery 30 with the reference value Sabref1 or with the reference value Sabref2. A modification may compare the voltage Vab of the auxiliary machinery battery 30 with a reference value Vabref1 or with a reference value Vabref2. The reference value Vabref1 and the reference value Vabref2 are determined respectively as voltages corresponding to the reference value Sabref1 and the reference value Sabref2.

The electric vehicle 20 of the first embodiment or the electric vehicle 120 of the second embodiment uses the main battery 26 as the first power storage device. According to a modification, a capacitor may be employed as the first power storage device.

According to the above embodiments, the present disclosure is implemented as the configurations of the electric vehicles 20 and 120 equipped with the motor 22. According to a modification, the present disclosure may be implemented as the configuration of a hybrid vehicle equipped with both a motor and an engine.

In the vehicle according to the above aspect of the present disclosure, the vehicle may further include a control device configured to control the switch such as to disconnect the second auxiliary machine from the low voltage-side power line, when a state of charge or a voltage of the second storage device becomes equal to or lower than a first reference value in such a state that the second auxiliary machine is connected with the low voltage-side power line in the system off-state. This configuration restricts an amount of reduction in the state of charge or in the voltage of the second power storage device after the state of charge or the voltage of the second power storage device becomes equal to or lower than the first reference value.

In this case, the control device may control the DC-DC converter to step down the voltage of the electric power of the high voltage-side power line and to supply the electric power of the stepped-down voltage to the low voltage-side power line, when the state of charge or the voltage of the second power storage device becomes equal to or lower than a second reference value that is smaller than the first reference value in such a state that the second auxiliary machine is disconnected from the low voltage-side power line in the system off-state. This configuration restricts a further reduction in the state of charge or in the voltage of the second power storage device after the state of charge or the voltage of the second power storage device becomes equal to or lower than the second reference value.

In the vehicle according to the above aspect of the present disclosure, the vehicle may further include a second switch configured to disconnect the second power storage device from the low voltage-side power line. In this case, the vehicle may further include a control device configured to control the switch such as to disconnect the second auxiliary machine from the low voltage-side power line, when a state of charge or a voltage of the second power storage device becomes equal to or lower than a first reference value in such a state that the second auxiliary machine and the second power storage device are connected with the low voltage-side power line in the system off-state, when the state of charge or the voltage of the second power storage device subsequently becomes equal to or lower than a second reference value that is smaller than the first reference value, the control device controlling the DC-DC converter such as to step down the voltage of the electric power of the high voltage-side power line and to supply the electric power of the stepped-down voltage to the low voltage-side power line, while controlling the second switch such as to disconnect the second power storage device from the low voltage-side power line. This configuration enables dark current to be supplied from the high voltage-side power line (first power storage device) via the DC-DC converter and the low voltage-side power line to the first auxiliary machine and restricts a further reduction in the state of charge or in the voltage of the second power storage device after the state of charge or the voltage of the second power storage device becomes equal to or lower than the second reference value.

In the vehicle according to the above aspect of the present disclosure, the vehicle may further include a relay provided in the high voltage-side power line that is arranged to connect a drive device for running with the first power storage device. The DC-DC converter may be connected with a first power storage device-side of the relay in the high voltage-side power line and with the low voltage-side power line. This configuration enables dark current to be supplied from the first power storage device via the DC-DC converter and the low voltage-side power line to the first auxiliary machine without turning on the relay, i.e., without electrically connecting the drive device with the first power storage device, in the system off-state.

The following describes the correspondence relationship between the primary components of the embodiment and the primary components of the disclosure described in Summary. The main battery 26 of the embodiment corresponds to the “first power storage device”, the auxiliary machinery battery 30 corresponds to the “second power storage device”, and the sub DC-DC converter 34 corresponds to the “DC-DC converter” in the above aspect of the present disclosure.

The correspondence relationship between the primary elements of the above embodiment and the primary elements in the above aspects of the present disclosure described in Summary, however, does not intend to limit the elements in the aspects of the present disclosure described in Summary, since the above embodiment is only one example for concretely describing some aspects of the present disclosure described in Summary. In other words, the aspects of the present disclosure described in Summary should be construed on the basis of the description in Summary. The embodiment is only one concrete example of the present disclosure described in Summary.

Some aspects of the present disclosure are described above with reference to the embodiment and its modifications. The present disclosure is, however, not limited to any of the embodiment and its modifications described above but may be implemented by any of various other aspects within the scope of the present disclosure.

### INDUSTRIAL APPLICABILITY

The present disclosure is applicable to the manufacturing industries of the vehicle and so on.

What is claimed is:

1. A vehicle, comprising:
a first power storage device;
a second power storage device configured to have a lower rated voltage than a rated voltage of the first power storage device;
a DC-DC converter configured to step down a voltage of electric power of a high voltage-side power line which the first power storage device is connected with and to supply the electric power of the stepped-down voltage to a low voltage-side power line which the second power storage device is connected with;
a first auxiliary machine connected with the low voltage-side power line and configured such as to be required to operate in a system off-state;
a second auxiliary machine connected with the low voltage-side power line and configured such as not to be required to operate in the system off-state; and
a switch configured to disconnect the second auxiliary machine from the low voltage-side power line.

2. The vehicle according to claim 1, further comprising:
a control device configured to control the switch such as to disconnect the second auxiliary machine from the low voltage-side power line, when a state of charge or a voltage of the second storage device becomes equal to or lower than a first reference value in such a state that the second auxiliary machine is connected with the low voltage-side power line in the system off-state.

3. The vehicle according to claim 2,
wherein the control device controls the DC-DC converter to step down the voltage of the electric power of the high voltage-side power line and to supply the electric power of the stepped-down voltage to the low voltage-side power line, when the state of charge or the voltage of the second power storage device becomes equal to or lower than a second reference value that is smaller than the first reference value in such a state that the second auxiliary machine is disconnected from the low voltage-side power line in the system off-state.

4. The vehicle according to claim 1, further comprising:
a second switch configured to disconnect the second power storage device from the low voltage-side power line.

5. The vehicle according to claim 4, further comprising:
a control device configured to control the switch such as to disconnect the second auxiliary machine from the low voltage-side power line, when a state of charge or a voltage of the second power storage device becomes equal to or lower than a first reference value in such a state that the second auxiliary machine and the second power storage device are connected with the low voltage-side power line in the system off-state,
when the state of charge or the voltage of the second power storage device subsequently becomes equal to or lower than a second reference value that is smaller than the first reference value, the control device controlling the DC-DC converter such as to step down the voltage of the electric power of the high voltage-side power line and to supply the electric power of the stepped-down voltage to the low voltage-side power line, while controlling the second switch such as to disconnect the second power storage device from the low voltage-side power line.

6. The vehicle according to claim 1, further comprising:
a relay provided in the high voltage-side power line that is arranged to connect a drive device for running with the first power storage device, wherein
the DC-DC converter is connected with a first power storage device-side of the relay in the high voltage-side power line and with the low voltage-side power line.
